(19) United States
(12) Patent Application Publication
(10) Pub. No.: US 2011/0226297 A1
(43) Pub. Date: Sep. 22, 2011

(54) COLLAPSIBLE COVER SECURED TO AN AUTOMOBILE

(76) Inventor: Darrel A. REWIS, Jefferson, GA (US)

(21) Appl. No.: 13/051,173

(22) Filed: Mar. 18, 2011

Related U.S. Application Data
(60) Provisional application No. 61/340,599, filed on Mar. 19, 2010.

(51) Int. Cl. E04H 15/06; F16M 13/02; H01F 7/02; A44B 18/00

(52) U.S. Cl. 135/88.05; 248/205.1; 248/220.21; 248/206.5; 248/205.2; 248/201

(57) ABSTRACT

A canopy apparatus for use with a vehicle such as an automobile or pickup truck. The canopy includes a collapsible frame adapted to be removably mounted to a surface of the vehicle, for example to the bed of a truck or to the trunk of an automobile. The canopy apparatus also includes a cover adapted to be secured to the collapsible frame.

### CROSS-REFERENCE TO RELATED APPLICATION

This application claims the benefit of U.S. Provisional Patent Application Ser. No. 61/340,599, filed Mar. 19, 2010, the entirety of which is hereby incorporated herein by reference for all purposes.

### TECHNICAL FIELD

The present invention relates generally to the field of outdoor tents or canopies, and more particularly to tents used for tailgating activities in conjunction with an automobile.

### BACKGROUND

Outdoor events and sporting-events tailgating are very popular. Many people enjoy meeting outside of a stadium before an event and socializing, often for hours under the rays of the Sun. It is unhealthy for people to be exposed to such an amount of sun. Further, these people oftentimes enjoy use of a barbeque grill or cooler. Exposure of these items to the Sun or rain can cause damage to the surface or overheat the contents. It is to the described situations and other advantages that the present invention is primarily directed.

### SUMMARY

Example forms of the present invention generally include a canopy made of lightweight, UV-protective and rain-resistant material attached to a lightweight, collapsible frame, which may be adapted to be attached to a truck bed or tailgate. The canopy is optionally fully supported by one or more arm(s) or other support members attached to the vehicle.

In one aspect, the present invention relates to a canopy for use with an automobile preferably including a collapsible frame adapted to be removably mounted to a surface of the automobile. The canopy preferably also includes a cover adapted to be secured to the collapsible frame.

In another aspect, the present invention relates to a canopy for use with an automobile preferably including a collapsible frame with at least one mast hingedly secured to at least one arm. The canopy preferably also includes a cover adapted to be secured to the collapsible frame.

In still another aspect, the present invention relates to a canopy for use with an automobile preferably including a pair of collapsible frames. Each frame preferably includes a mast and an arm. The frame preferably also includes a pair of rods with each rod being secured between the pair of collapsible frames. The canopy preferably also includes a flexible cover secured with respect to the pair of collapsible frames and the pair of rods.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

A full and enabling disclosure of the present invention, including the best mode thereof, directed to one of ordinary skill in the art, is set forth in this specification, which makes reference to the appended drawings, in which:

FIG. 1 is a side elevational view of a canopy apparatus in accordance with an example embodiment of the present invention;

FIG. 2 is a front perspective view of the canopy apparatus depicted in FIG. 1;

FIG. 3 is a top plan view of the canopy apparatus depicted in FIG. 1;

FIG. 4 is a rear perspective view of the canopy apparatus depicted in FIG. 1;

FIG. 5 is a side elevational view of frames for use with the canopy apparatus depicted in FIG. 1;

FIG. 6 is a side elevational view of the frames depicted in FIG. 5 showing operation of frame hinges;

FIG. 7 shows left and right side views of the frame arms of FIG. 5, shown in a fully collapsed position;

FIG. 8 is a right side elevational view of the canopy apparatus depicted in FIG. 1, shown in a collapsed position;

FIG. 9 is a perspective view of an example embodiment of a storage container for use with a collapsed canopy apparatus such as depicted FIG. 1;

FIG. 10 is a perspective view of another embodiment of a storage container for use with a collapsed canopy apparatus such as depicted in FIG. 1;

FIG. 11 shows mounting hardware elements for use with a canopy apparatus such as depicted in FIG. 1; and

FIG. 12 is a perspective view of an example embodiment of a cover for use with a canopy apparatus such as depicted in FIG. 1.

Repeat use of reference characters in the present specification and drawings is intended to represent same or analogous features or elements of the invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

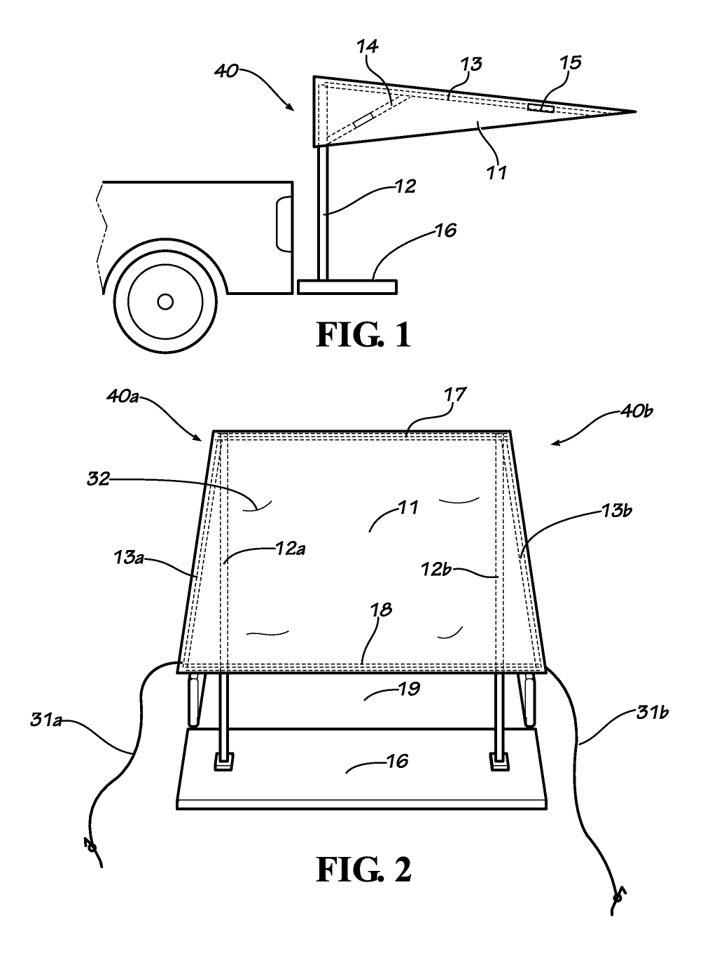

With reference to the drawing figures, wherein like reference numbers represent corresponding parts throughout the several views, FIG. 1 is a side view of an entire collapsible canopy apparatus secured to an automobile tailgate 16. It conveys the general shape, size and primary mounting position of the apparatus when fully engaged. In the depicted embodiment, the canopy or cover side 11 provides space for personalization and/or interchangability. For example, one might utilize a bright orange canopy for safety and visibility in one application, and then change to a canopy that displays the colors or logo of an alma mater for another application. Preferably, the cover is constructed of lightweight, UV protective and rain-resistant material, such as for example nylon or plastic. The cover 11 can be secured to a frame 40 in such a way that it remains upon the frame during collapse and storage but is easily removed from the frame for cleaning or canopy exchange, for example via hook-and-loop or tie straps or similar affixing means and method. This will allow one to interchange canopies for different applications.

The apparatus can be mounted in various locations of a truck bed, tailgate or vehicle trunk by utilizing various mounting options made available for the apparatus. The frame 40 as depicted includes a pair of upright masts 12 (designated as 12a and 12b in figures showing both) and a pair of horizontally-extending arms 13. Each mast 12 can optionally be angled or curved toward the bed slightly for greater balance. As depicted, each arm 13 can optionally extend at a slight downward angle from the horizontal axis.

FIG. 2 is a front perspective view of the entire apparatus in the fully engaged position. This view also displays optional ground-securing tie-downs 31a and 31b. The tie-downs 31a and 31b are preferably secured to the distal end of the horizontal arms 13a and 13b and extend to the ground where they can be secured by tent pegs or weights. While preferably constructed of rope, the tie-downs 31a and 31b can alternatively be constructed of bungee cord, strap material, and/or other suitable materials depending on the application of the canopy 11. In addition, this view shows several strategically placed half moon shaped wind-slits 32 that are designed to allow air to move through the cover 11 surface thus lessoning the stress on the cover and/or frame 40a and 40b. The location, number and size of the wind-slits 32 may vary depending on the size and application of the cover 11.

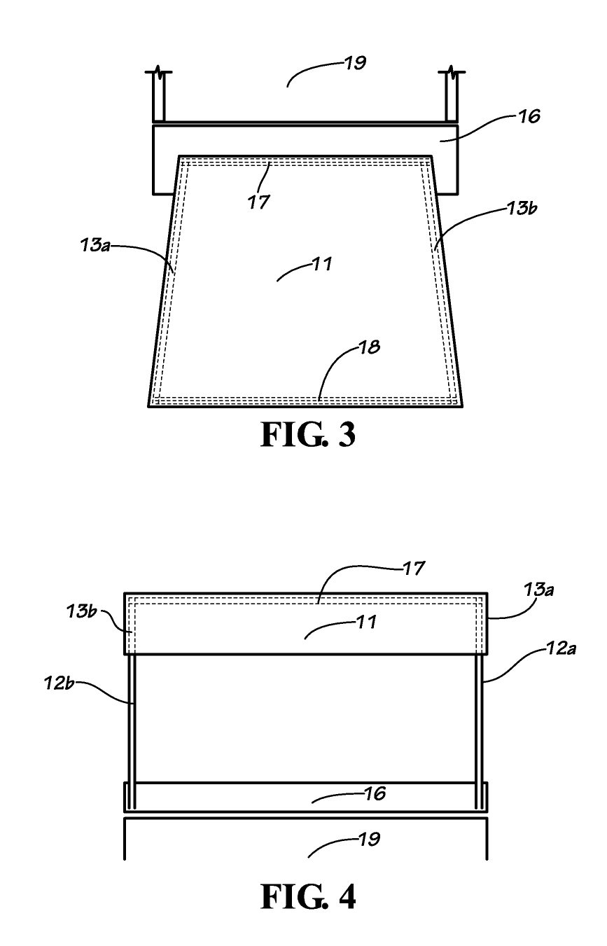

FIG. 3 is a top plan view of the apparatus in the fully engaged and upright position. This view highlights the general shape of the cover 11. The top portion of the cover 11 has the greatest surface space for personalization. Note that the cover 11 edge furthest from (distal) the tailgate 16 optionally has a greater width than the edge nearest (proximate) the tailgate 16, resulting in a trapezoidal profile tapering wider toward the rear or distal end of the canopy. This allows the apparatus to be attached to the smallest width tailgates currently available in the marketplace while maximizing shade coverage away from the tailgate 16. The example apparatus can be a “one size fits all” product. To accomplish this in the frame 40a and 40b horizontal arms 13a and 13b are mounted on an angle pitched away from each other as they extend from the upright masts 12a and 12b thus supporting the increased width of the distal cover 11 edge.

FIG. 4 is a rear elevational view of the entire apparatus from the bed of the truck 19 in the fully engaged position. In this view the cover 11 wraps around the horizontal arms 13a and 13b providing shade and additional opportunity for personalization.

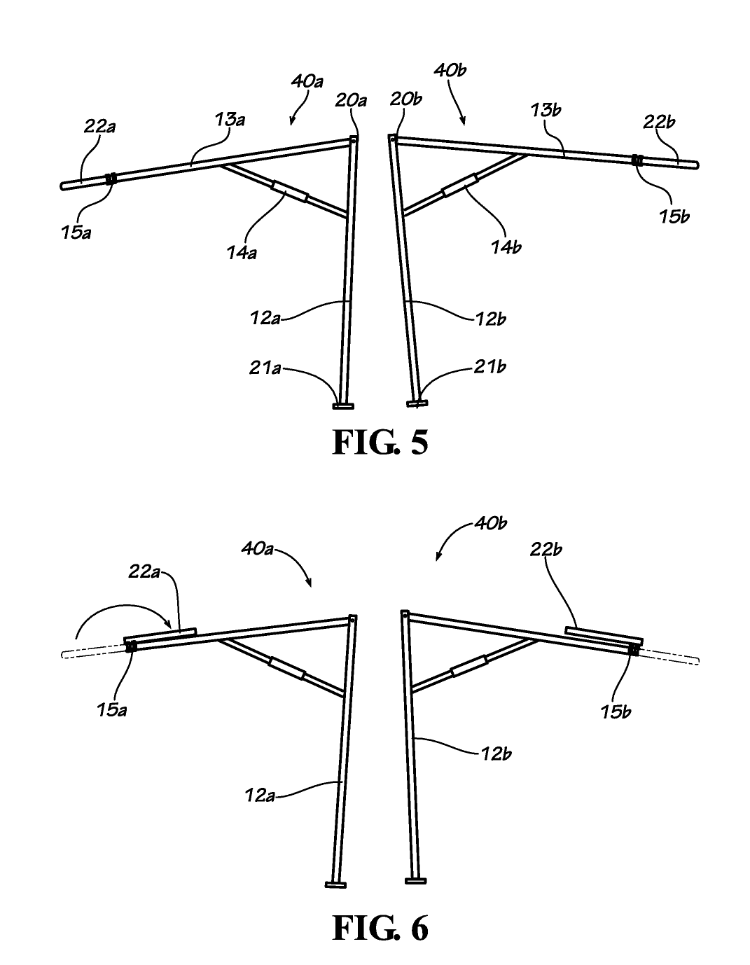

FIG. 5 is a side elevational view of the example frames 40a and 40b in a fully engaged position. Each frame 40a and 40b of the depicted example embodiment comprises an upright mast 12a and 12b that is about four to five feet tall when fully extended by securing members with a securing mechanism and a horizontal arm 13a and 13b that is about five to seven feet in length when fully extended by securing members 22a and 22b through the securing mechanism 15a and 15b. The frame can be constructed, for example, of powder-coated, hollow steel, aluminum, PVC, carbon-fiber, graphite, or other type of structurally supportive material, having a diameter of between about 0.5 to 1.5 inch in example forms. Each upright mast 12a and 12b is pivotally secured to a respective horizontal arm 13a and 13b at one respective connecting point 20a and 20b in such a way that allows movement for extension and collapse of the tent. In one preferred embodiment, a locking spreader or hinge type connection 14a and 14b is positioned intermediate the upright mast 12a and 12b and the horizontal arm 13a and 13b to provide stability and triangular bracing between the upright and horizontal arms and to allow the horizontal arms 13a and 13b and members 22a and 22b to move into a collapsed position for storage.

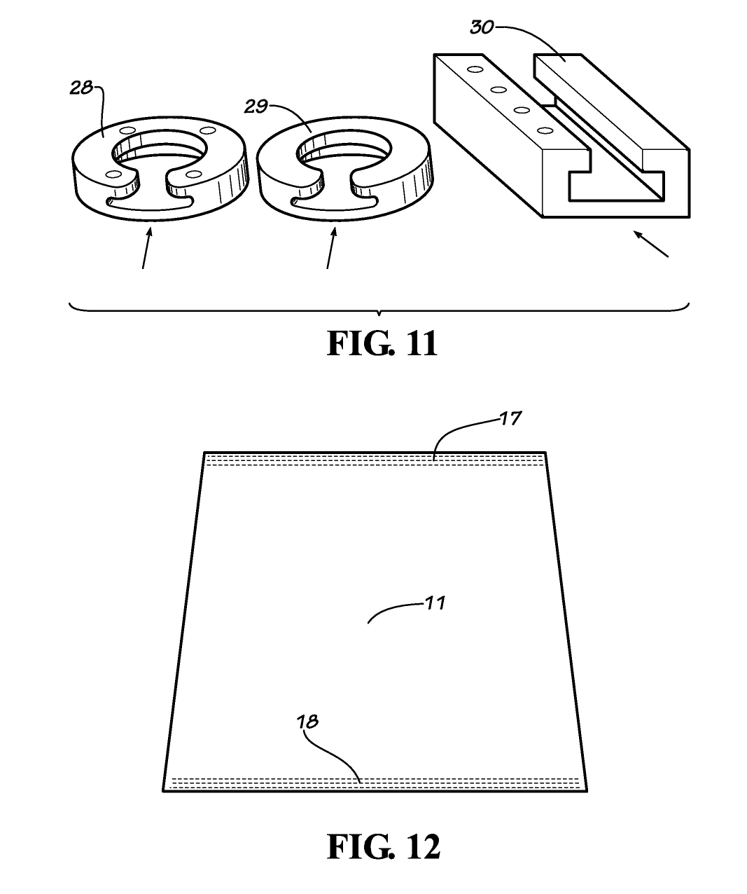

At the bottom of the upright masts 12a and 12b are base plates 21a and 21b. The base plates 21a and 21b are preferably permanently affixed to the upright masts 12a and 12b by weldments or other appropriate connection means depending on the material used for the upright mast and base plate. For example, the base plates 21a and 21b and the upright masts 12a and 12b can secured with pins, screws, bolts or any other fastener suitable for the material and application of the apparatus. The base plates 21a and 21b are secured with respect to various mounting apparatuses 28, 29 and 30 described more fully in FIG. 11.

FIG. 6 shows side elevational views of the frames 40a and 40b showing securing mechanisms 15a and 15b in a collapsed position thus folding the end section of the members 22a and 22b over the respective main sections of the horizontal arms 13a and 13b. Example securing mechanisms 15a and 15b can include a hinge or separable parts such as tube sections having interengaging pin and ferrule or sleeve couplings optionally secured with internal cording such as shock-cords. Alternatively, the separable sections of the members 22a and 22b could also be collapsed in a telescoping fashion utilizing construction including tubing that is smaller than the main section of the horizontal arm 13a and 13b.

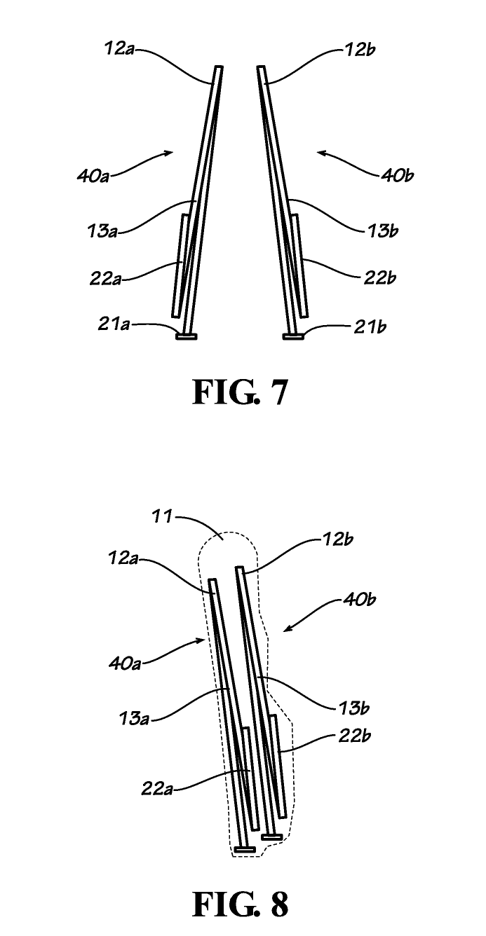

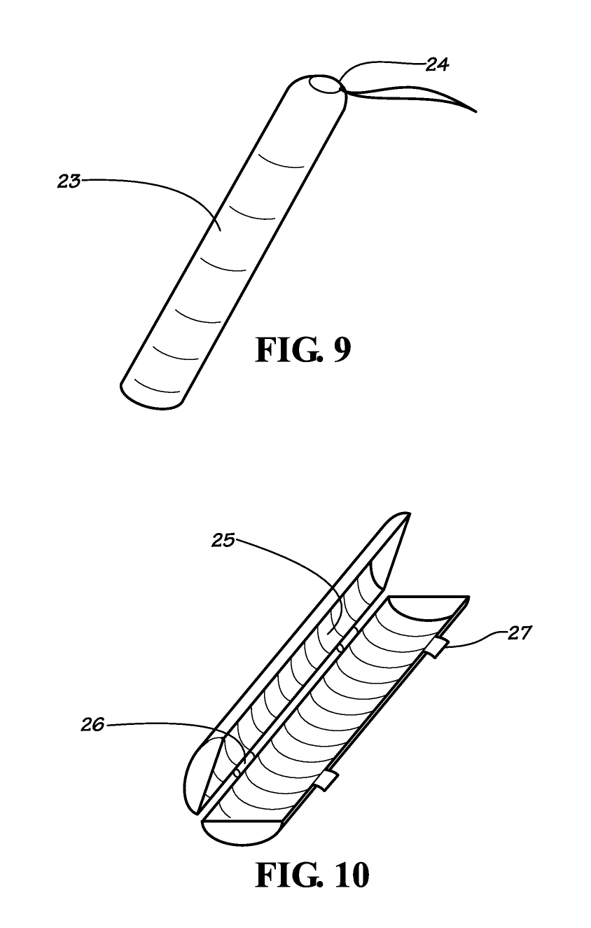

FIG. 7 shows the frames 40a and 40b in a fully collapsed position ready for storage. FIG. 8 is a right side plan view of the apparatus including both frames 40a and 40b with attached canopy 11 in the fully collapsed position ready for inserting into a storage bag 23 or canister 25 further described in FIG. 9.

FIG. 9 is a perspective view of a storage bag 23. It is designed for storage and transportation of the apparatus while providing a degree of protection from damage in storage, in transportation and/or by the elements. It can be closed with an attached drawstring 24.

FIG. 10 is a perspective view of a hard shell storage canister 24. It can be constructed of plastic and designed to provide even greater protection of the apparatus from damage in storage, in transportation and/or by the elements. It opens lengthwise by hinge(s) 26 and closes by latch(es) 27. The hard shell storage container may be formed from any suitable polymer or metal and may contain a coating to protect the outer surface of the canister. Such coatings may be power coatings, elastomers, polymers, etc.

FIG. 11 shows example mounting brackets designed to secure the upright masts 12a and 12b to the vehicle surface. A first example mounting plate bracket 28 is a steel flange that affixes to the truck bed or tailgate with metal screws or other suitable fastener(s). Preferably, the base plates 21a and 21b of the upright masts 12a and 12b manually slide or snap securely into the example mounting bracket 28 through an aperture, thus providing the connecting point to the vehicle surface. A second example mounting plate bracket 29 is a magnetically affixed flange that can be attached and removed from a vehicle trunk, truck bed or tailgate in place of the more permanent mounts utilizing screws as in mounting plate bracket 28. A third example mounting bracket 30 is a rail type bracket that can either screw down or be magnetically affixed to the truck bed or tailgate. This third example 30 is intended to allow the upright base plates 21a and 21b to be slid and locked into various positions along the length of the rail to providing greater maneuverability as to the placement of the entire apparatus, for example allowing the apparatus to slide forward and back along at least a portion of the length, and optionally along the entire length of a truck bed. The screwed-in mounts remain on the vehicle but the magnetic mounts are optionally removed and stored in the bag 23 or canister 25. The arrows in FIG. 11 represent the direction the base plates 21a and 21b are to be inserted into the mounts. It should be understood that various other mounting bracket designs are contemplated within the scope of the invention and the above described brackets are provided as examples of bracket styles for use with particular embodiments of the present invention. It should also be understood that one or more of the different described bracket formats can be used simultaneously with the present invention.

FIG. 12 shows an example embodiment of the canopy 11 from above with two support rods 17 and 18 shown connected to the canopy. The support rods 17 and 18 separate and extend between the frames 40a and 40b (shown in FIG. 2) and keep the secured canopy 11 taught. Proximal rod 17 as depicted preferably has a length about equal to the distance between the mast arms 12a and 12b (for example about 4-5 feet), and optionally can collapse to a length no greater than the height of the upright mast 12a and 12b for storage purposes. Distal rod 18 as depicted has a length equal to the distance between the distal ends of the horizontal arms 13a and 13b and extension members 22a and 22b (for example about 5-7 feet) in the fully engaged position, and optionally collapses to a length no greater than the height of the upright mast 12a and 12b for storage purposes. Each support rod 17 and 18 can utilize tent pole-type rod joints with pin and ferrule or sleeve couplings and elastic connecting shock-cords within the rod itself. However, it should be understood that the rod joints can alternatively be constructed of telescoping rods, screw connecting rods or any other rod design that allows the length of the rod to be adjusted and/or collapsed during storage.

While the invention has been described with reference to preferred and example embodiments, it will be understood by those skilled in the art that a variety of modifications, additions and deletions are within the scope of the invention, as defined by the following claims.

What is claimed is:

1. A canopy for use with an automobile, comprising:
a collapsible frame adapted to be removably mounted to a surface of the automobile; and
a cover adapted to be secured to the collapsible frame.

2. The canopy of claim 1, further comprising at least one mounting bracket secured to the surface of the automobile, wherein the collapsible frame comprises at least one mounting base adapted to be removably secured with respect to the at least one mounting bracket.

3. The canopy of claim 2, wherein the at least one mounting bracket comprises a flange having an aperture for receiving the at least one mounting base.

4. The canopy of claim 2, wherein the at least one mounting bracket is permanently secured to the surface of the automobile with a fastener.

5. The canopy of claim 2, wherein the at least one mounting bracket is magnetically secured to the surface of the automobile.

6. The canopy of claim 1, wherein the cover is secured to the collapsible frame with at least one hook-and-loop attachment means.

7. The canopy of claim 1, wherein the cover comprises at least one ground-securing member secured to the collapsible frame.

8. A canopy for use with an automobile, comprising:
a collapsible frame comprising at least one mast pivotally secured to at least one arm; and
a cover adapted to be secured to the collapsible frame.

9. The canopy of claim 8, wherein the at least one mast comprises a plurality of collapsible members removably secured with respect to each other.

10. The canopy of claim 8, wherein the at least one arm comprises a plurality of collapsible members removably secured with respect to each other.

11. The canopy of claim 8, wherein the at least one arm is longer than the at least one mast.

12. The canopy of claim 8, wherein the frame comprises at least one hinge secured between the at least one mast and the at least one arm.

13. The canopy of claim 8, wherein the frame comprises at least one anchor adapted to removably secure to the surface of an automobile.

14. The canopy of claim 8, wherein the canopy comprises a flexible material.

15. A canopy for use with an automobile, comprising:
a pair of collapsible frames, wherein each frame comprises a mast and an arm;
a pair of rods, wherein each rod is secured between the pair of collapsible frames; and
a flexible cover secured with respect to the pair of collapsible frames and the pair of rods.

16. The canopy of claim 15, wherein each collapsible frame further comprises a hinge secured between the mast and the arm.

17. The canopy of claim 15, wherein each arm comprises a proximal end and a distal end, wherein a proximal rod extends from a first arm proximal end to a second arm proximal end, and wherein a distal rod extends from a first arm distal end to a second arm distal end.

18. The canopy of claim 17, wherein the distal rod is longer than the proximal rod.

19. The canopy of claim 15, further comprising a pair of mounting brackets secured to the automobile.

20. The canopy of claim 19, wherein the pair of frames are adapted to be removably secured with respect to the pair of mounting brackets.
